(19) United States
(12) Patent Application Publication
(10) Pub. No.: US 2024/0185441 A1
(43) Pub. Date: Jun. 6, 2024

(54) IMAGE SENSOR APPARATUS FOR CAPTURING DEPTH INFORMATION USING EDGE COMPUTING

(71) Applicant: CISTA SYSTEM CORP., Grand Cayman (KY)

(72) Inventors: Zhaojian LI, FREMONT, CA (US); Jiangtao PANG, FREMONT, CA (US)

(21) Appl. No.: 18/076,257

(22) Filed: Dec. 6, 2022

(51) Int. Cl. G06T 7/50; G06T 5/00; G06T 7/194

(52) U.S. Cl. CPC G06T 7/50; G06T 5/002; G06T 7/194; G06T 2207/20024; G06T 2207/20228

(57) ABSTRACT

This application describes apparatuses and systems for rendering the Bokeh effect using stereo vision with edge computing. An example apparatus may include a first sensor and a second sensor. The first sensor is configured to: capture a first view of a scene. The second sensor is configured to: capture a second view of the scene, and send the second view of the scene to the first sensor. The first sensor is further configured to: receive the second view of the scene, compute a depth map of the scene based on the first view of the scene and the second view of the scene; and render Bokeh effect to an image of the scene based on the depth map.

### TECHNICAL FIELD

The disclosure relates generally to an apparatus and device for capturing depth information by implementing edge computing on a primary sensor and one or more secondary sensors.

### BACKGROUND

The Bokeh effect is used in photography to produce images where the closer objects look sharp and everything else stays out-of-focus. Depth mapping that identifies the background and the foreground is the core of Bokeh effect production. Most modern cameras, smartphones, tablets, monitors, or other devices obtain depth information by leveraging multiple image sensors, such as dual-camera or tri-camera configurations. These image sensors effectively form a stereo vision that simulates human binocular vision to perceive depth information. Different image sensors in the camera may capture a scene (e.g., a target object) from different views, and these different views are then transferred out of the camera into a standalone processor for extracting depth information and rendering the Bokeh effect. The standalone processor (e.g., with one or more cores) is usually the processor of the hosting device on which the camera is installed. For instance, the camera component of a smartphone uses multiple image sensors to capture multiple different views of a scene and sends these views to the smartphone's processor for post-processing, e.g., computing depth information and rendering The Bokeh effect to the image of the scene. However, this traditional architecture suffers various technical limitations.

### SUMMARY

Various embodiments of this specification may include hardware circuits, systems, and methods related to capturing depth information using primary and secondary image sensors powered by edge computing.

In some aspects, the techniques described herein relate to an image apparatus, including: a first sensor including a first image sensor array, a first data transceiver, and a first processor; a second sensor including a second image sensor array and a second data transceiver; wherein: the first sensor is configured to: capture, using the first image sensor array, a first view of a scene; the second sensor is configured to: capture, using the second image sensor array, a second view of the scene, and send, using the second data transceiver, the second view of the scene to the first sensor; the first sensor is further configured to: receive, using the first data transceiver, the second view of the scene, compute, using the first processor, a depth map of the scene based on the first view of the scene and the second view of the scene; and render, using the first processor, Bokeh effect to an image of the scene based on the depth map.

In some aspects, the first sensor is further configured to send, using the first data transceiver, the image of the scene with the rendered Bokeh effect to a display.

In some aspects, the first data transceiver and the second data transceiver include mobile industry processor interfaces (MIPI).

In some aspects, to compute the depth map of the scene, the first sensor is further configured to: determine a disparity between the first view and the second view of the scene; and generate depth information based on the disparity and position information of pixels that are captured in the first view and the second view of the scene.

In some aspects, to render the Bokeh effect to an image of the scene, the first sensor is further configured to: generating the image of the scene based on the first view of the scene and the second view of the scene; determine a foreground and a background of the image of the scene based on the depth map; determine a depth of the background of the scene based on the depth map; and performing linear or non-linear filtering to blur the background of the image depending on a depth of the background.

In some aspects, the image apparatus may further include a third sensor including a third image sensor array and a third data transceiver, wherein the third sensor is configured to: capture, using the third image sensor array, a third view of the scene, and send, using the third data transceiver, the third view of the scene to the first sensor; the first sensor is further configured to: receive, using the first data transceiver, the third view of the scene, and compute, using the first processor, the depth map of the scene based on the first view of the scene, the second view of the scene, and third view of the scene.

In some aspects, the second sensor further includes a second processor, and is further configured to: receive an instruction indicating a demotion of the first sensor and a promotion of the second sensor, receive, using the second data transceiver, the third view of the scene from the third sensor, compute, using the second processor, the depth map of the scene based on the second view of the scene and third view of the scene, and render, using the second processor, Bokeh effect to the image of the scene based on the depth map.

In some aspects, the instruction is received when a hardware failure is detected on the first sensor.

In some aspects, the first sensor is configured to send an acknowledgement signal to the second sensor after receiving the second view of the scene, and when the acknowledgement signal is not received within a threshold time window, the second sensor is configured to: generate the instruction, and notify the third sensor to redirect future data to the second sensor.

In some aspects, the image apparatus may further include a third sensor including a third image sensor array and a third data transceiver, wherein the third sensor is configured to be in a power-saving mode by default.

In some aspects, the second sensor further includes a second processor, and is further configured to: receive an instruction indicating a demotion of the first sensor and a promotion of the second sensor, and send an enabling signal to the third sensor to wake up from the power-saving mode.

In some aspects, the third sensor, when wakes up from the power-saving mode, is configured to: capture, using the third image sensor array, a third view of the scene, and send, using the third data transceiver, the third view of the scene to the second sensor.

In some aspects, the second sensor is further configured to: receive, using the second data transceiver, a third view of the scene from the third sensor, compute, using the second processor, the depth map of the scene based on the second view of the scene and third view of the scene, and render, using the second processor, Bokeh effect to an image of the scene based on the depth map.

In some aspects, the first processor includes an application-specific integrated circuit (ASIC) designed for rendering Bokeh-effect.

In some aspects, the ASIC is programmed according to at least a noise distribution of the first image sensor array.

In some aspects, the first image sensor array and the second image sensor array are homogeneous sensors.

In some aspects, the techniques described herein relate to a hardware device, including: a camera component and a display, wherein the camera component includes: a first sensor including a first image sensor array, a first data transceiver, and a first processor; a second sensor including a second image sensor array and a second data transceiver; wherein: the first sensor is configured to: capture, using the first image sensor array, a first view of a scene; the second sensor is configured to: capture, using the second image sensor array, a second view of the scene, and send, using the second data transceiver, the second view of the scene to the first sensor; the first sensor is further configured to: receive, using the first data transceiver, the second view of the scene, compute, using the first processor, a depth map of the scene based on the first view of the scene and the second view of the scene; render, using the first processor, Bokeh effect to an image of the scene based on the depth map; and send the image of the scene with the rendered Bokeh effect to the display for displaying.

These and other features of the systems, methods, and hardware devices disclosed, and the methods of operation and functions of the related elements of structure and the combination of parts and economies of manufacture will become more apparent upon consideration of the following description and the appended claims referring to the drawings, which form a part of this specification, where like reference numerals designate corresponding parts in the figures. It is to be understood, however, that the drawings are for illustration and description only and are not intended as a definition of the limits of the invention.

### BRIEF DESCRIPTION OF THE DRAWINGS

FIG. 1 Illustrates a comparison between a traditional hosting device with an image-collecting camera and a hosting device with an edge camera, according to some embodiments of this specification.

FIG. 2 Illustrates an exemplary internal structure of the edge camera, according to some embodiments of this specification.

FIG. 3A Illustrates an exemplary three-sensor edge camera with hardware fault tolerance, according to some embodiments of this specification.

FIG. 3B Illustrates another exemplary three-sensor edge camera, according to some embodiments of this specification.

FIG. 3C Illustrates another exemplary three-sensor edge camera with hardware fault tolerance, according to some embodiments of this specification.

FIG. 4 Is a schematic diagram of an example edge camera for rendering the Bokeh effect, according to some embodiments of this specification.

### DETAILED DESCRIPTION

The specification is presented to enable any person skilled in the art to make and use the embodiments, and is provided in the context of a particular application and it's requirements. Various modifications to the disclosed embodiments will be readily apparent to those skilled in the art, and the general principles defined herein may be applied to other embodiments and applications without departing from the spirit and scope of the present specification. Thus, the specification is not limited to the embodiments shown but is to be accorded the widest scope consistent with the principles and features disclosed herein.

As described in the background section, modern devices with cameras are generally able to render the Bokeh effect to images. Rendering the Bokeh effect requires depth information of the objects in the captured scene in order to determine foreground and background. The cameras are usually equipped with at least two image sensors to capture the same scene from at least two different angles, which may also be called views.

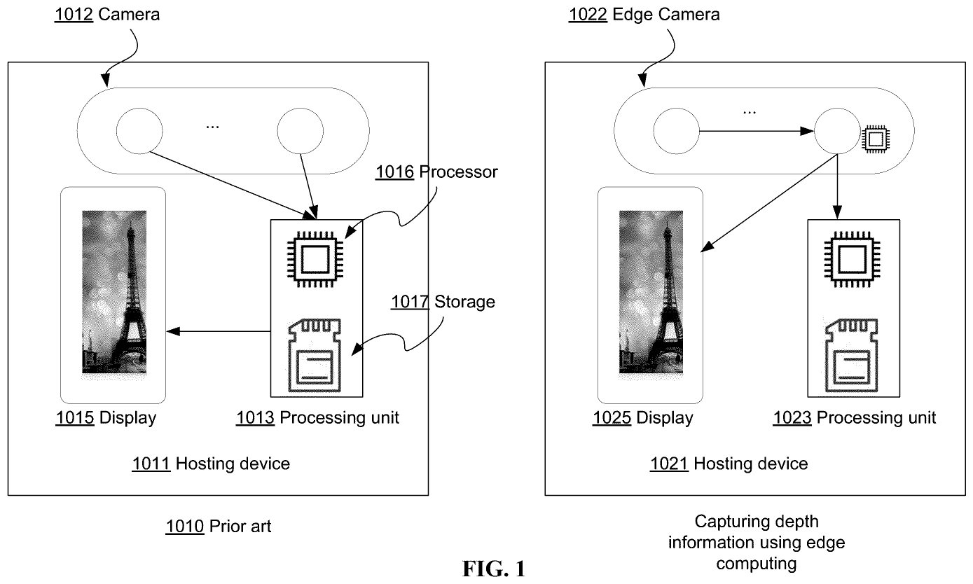

As shown in FIG. 1, the prior art 1010 hosting device 1011 includes a camera 1012 with a plurality of image sensors (only two are illustrated in FIG. 1). Here, the hosting device 1011 may be a smartphone, an autonomous driving vehicle, a tablet, a monitor, a laptop, etc. The plurality of image sensors work collectively to provide a stereo vision and captures different views of the same scene. These captured views are then sent to the on-device processing unit 1013 for data processing. In some cases, the on-device processing unit 1013 includes a processor 1016 and a storage unit 1017 (e.g., internal memory). The processing unit 1013 may perform various computing tasks on the received views to generate an image of the scene with rendered Bokeh effect. Then the image may be sent to a display 1015 for displaying to the user.

During this process, the camera 1012 in the prior art 1010 is used simply for capturing different views of a target scene and sending the captured views to the on-device processing unit 1013 for processing. This design suffers several technical limitations.

First, the data volume being migrated is not optimally minimized. For instance, when multiple image sensors in the camera 1012 capture respective views, they usually need to be aggregated before being sent out. This is because the camera 1012 is usually equipped with one data transmitter, and all image sensors have to use the same data transmitter. Once the views are aggregated, the camera 1012 sends the views to the on-device processing unit 1013, which means the same data are being transmitted again out of the camera (e.g., sometimes compression may be involved). After the on-device processing unit 1013 generates the final image with the Bokeh effect, it sends the image to the display 1015, which is another data transfer.

Second, the processor 1016 in the on-device processing unit 1013 needs to accommodate cameras with different specifications. Using a smartphone as an example, it is common that different smartphone companies use the same processor manufactured by one company, and use cameras from different companies. Thus the processor manufacturer may have to design its processor to be more inclusive and deal with different cameras with various hardware and software specifications. This naturally leads to an inefficient chip design and likely high power-consuming processors.

To address the above issues, an edge computing-based camera configuration is described. As an example, the hosting device 1021 is designed to capture depth information and render the Bokeh effect using edge computing. Edge computing refers to a distributed computing paradigm that brings computation and data storage closer to the sources of data. Edge computing is expected to improve response times and save bandwidth. In the present use case involving Bokeh effect rendering, the hosting device 1021 may be equipped with an edge camera 1022, which includes one primary image sensor and a secondary image sensor.

In some embodiments, the primary sensor may include a first image sensor array, a first data transceiver, and a first processor, and the secondary sensor may include a second image sensor array and a second data transceiver. The sensors may also include other components such as lenses, pixels, color filters, etc. In some embodiments, the primary sensor and the secondary sensor may be configured differently (in comparison to the homogeneous sensors in camera 1012), in which the primary sensor comprises an additional processing unit, e.g., an application-specific integrated circuit (ASIC) chip specifically designed for computing depth information based on multiple views of the same scene and rendering Bokeh effect based on the depth information. In some embodiments, the primary sensor and the secondary sensor may both include their respective ASIC chips. The ASIC chip in the primary sensor may be active by default, and the ASIC chip in the secondary sensor may be in power-saving mode (e.g., sleeping mode) by default. The secondary sensor may monitor the activeness of the primary sensor and promote itself to a new primary sensor when the original primary sensor is compromised. For instance, the secondary sensor may expect an acknowledge signal from the primary sensor every time sending the captured view of the scene. If the acknowledge signal is not received within a threshold time window, the secondary sensor may promote itself to be the new primary sensor and send instructions to the original primary sensor requesting the (current and all future) views captured by the original primary sensor. In other words, there is only one primary sensor at any given point of time.

In some embodiments, the primary sensor is configured to (1) capture a first view of a scene. (2) receive a second view (different from the first view) of the same scene captured by the second sensor, and (3) computing a depth map of the scene based on the first view and the second view and rendering Bokeh effect based on the depth map. Here, the different “views” may refer to different “angles”. In other words, the secondary sensor works as a view-capturing sensor whereas the primary sensor is a hybrid sensor that handles both view-capturing, data aggregation, and data processing (e.g., a view-capturing and data-processing sensor).

Once the multiple views of the same scene are processed to generate the depth map, the primary sensor may generate an image of the scene, determine the foreground and background of the image based on the depth map, and render Bokeh effect to the image. The rendered image may then be directly sent to the display 1025 of the hosting device 1021 without the processing unit 1023 being involved. This way, the data processing workload is effectively offloaded to the edge camera 1022 from the centralized processing unit 1023.

This workload offloading provides at least two technical improvements. First, since the data gathering and data processing are all handled locally within the edge camera, the camera (1012 and 1022) becomes more independent from the processing unit 1023. Thus the processor manufacturer that manufactures the processing unit 1023 may be relieved from the requirements to accommodate different sensors from different sensor manufacturers. As explained above, image sensors from different manufacturers may have different technical specifications, such as noise distribution in the captured views. Processing views with different noise distributions using one type of processing unit 1023 may require more complex design logic. With the edge camera 1022, however, the native processor within the edge camera 1022 may be an ASIC that is specifically optimized to process the views (with the specific noise distribution) captured by the native sensors within the same edge camera 1022. For instance, the ASIC may be designed to perform noise reduction in a specific band, but not other bands, with the knowledge that the specific camera generates noises in that specific band but not others. In other words, different camera manufacturers may specifically fine-tune their own ASIC chips to handle the views captured by their respective image sensors. With an ASIC specifically tailored to handle the views captured by the image sensors, the edge camera 1022 may generate the depth map and render Bokeh effect with higher quality and in a more efficient way.

Second, there is less data migration among the edge camera 1022, processing unit 1023, and the display 1025. As a comparison, the existing architecture 1010 requires transmitting the captured views from the camera 1012 to processing unit 1013, and then the processed image from the processing unit 1013 to the display 1015. The edge-computing-based architecture only requires transmitting the processed image from the edge camera 1022 to the display 1025. In compact electronic devices like smartphones, tablets, or laptops, reducing the volume of data transmission is especially critical because it reduces heat generation and overall power consumption.

In some embodiments, the processor of the edge camera 1022 (e.g., an ASIC) may be designed for one or more specific functions, such as rendering Bokeh effect. For other functions not supported by the processor of the edge camera 1022, the views captured by the image sensors in the edge camera 1022 may be redirected to the processing unit 1023. For example, if the edge camera 1022 is equipped with an ASIC specifically designed for rendering Bokeh effect, the view gathering and processing are all executed locally within the edge camera 1022 when the user selects shooting modes that involve rending Bokeh effect (e.g., portrait mode, food mode). When the user selects other modes such as night mode or panorama, the edge camera 1022 may work as a traditional camera 1012 that captures the views and send the views to the processing unit 1023 of the hosting device for further processing. Thus, the edge camera 1022 further includes a task selection circuit, which keeps the tasks matching the local processor' specification, and redirects the other tasks to the remote processing unit 1023 (e.g., the processing unit on the hosting device 1021).

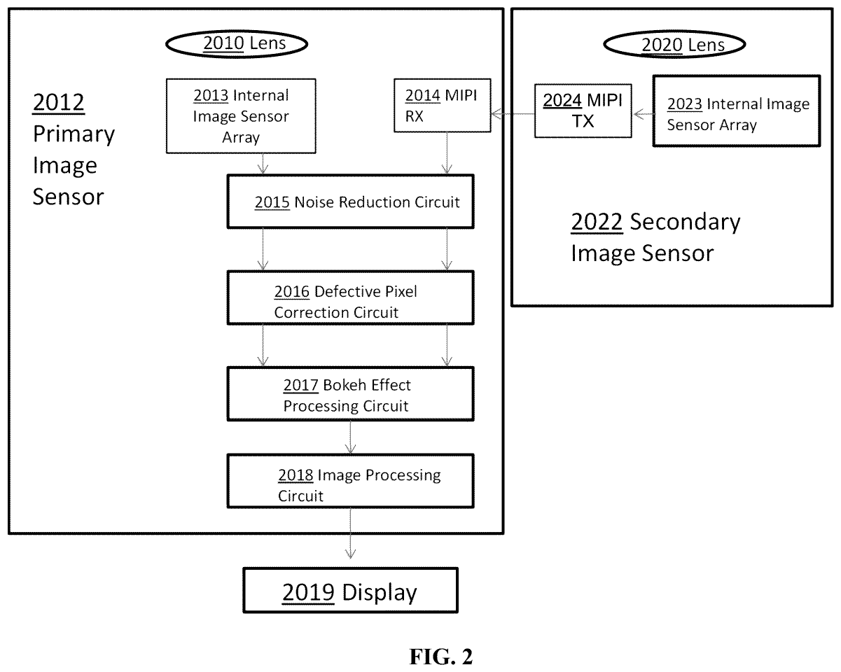

FIG. 2 Illustrates an exemplary internal structure of an edge camera, according to some embodiments of this specification. As described in FIG. 1, in some embodiments, the edge camera may include at least two image sensors, one primary image sensor 2012 and a secondary image sensor 2022. The image sensors may be charge-coupled device (CCD) image sensors or complementary metal-oxide semiconductor (CMOS) image sensors, that convert optical signals to electrical signals. The internal components illustrated in FIG. 2 are examples. Depending on the implementation, the sensors may include fewer, more, or alternative components.

In some embodiments, the primary image sensor 2012 may include one or more lenses 2010 (objective), an internal image sensor array 2013, a mobile industry processor interfaces (MIPI) transceiver 2014, and a plurality of data processing circuits. The data processing circuits may include a noise reduction circuit 2015, a defective pixel correction circuit 2016, a Bokeh effect processing circuit 2017, and an image processing circuit 2018.

In some embodiments, the secondary image sensor 2022 may include one or more lens 2020, a MIPI transceiver (MIPI TX) 2024, and an internal image sensor array 2023.

In addition to the above-described components, the primary image sensor 2012 and the secondary image sensor 2022 may further include a grid of pixels (referring to photodiodes or photosites in this disclosure), row access circuitry, column access circuitry, and a ramp signal generator. The pixels capture the light impinged on them and convert the optical signals to electrical signals. The row access circuitry controls which row of pixels the sensor will read. The column access circuitry includes column read circuits that read the signals from corresponding columns. The ramp signal generator generates a ramping signal as a global reference signal for column read circuits to record the converted electrical signal.

In some embodiments, the image sensor arrays 2013 and 2023 may each include a pixel array (e.g., millions of pixels) and one or more microlenses covering the pixels. A microlens is a small lens, generally with a diameter less than a millimeter (mm) and could be less than 2 micrometers (μm) when pixel size scales below 2 μm. A typical microlens may be a single element with one plane surface and one spherical convex surface to refract the light. The plurality of microlenses are sometimes arranged as an array, such as a one-dimensional or two-dimensional array on a supporting substrate. Single micro-lenses may be used to couple light to the covered pixels or photodiodes; microlens arrays may be used to increase the light collection efficiency of CCD arrays and CMOS sensors, to collect and focus light that would have otherwise fallen onto the non-sensitive areas of the sensors.

In some embodiments, the internal image sensor arrays 2013 and 2023 may each include a color filter array (CFA) or color filter mosaic (CFM), which is a mosaic of tiny color filters placed over the pixels of the image sensor to capture color information. The color filters filter the light by wavelength range, such that the separate filtered intensities include information about the color of light. For example, a Bayer pattern CFA gives information about the intensity of light in red, green, and blue (RGB) wavelength regions. The raw image data captured by the image sensor is then converted to a full-color image (with intensities of all three primary colors represented at each pixel) by a demosaicing algorithm which is tailored for each type of color filter. The spectral transmittance of the CFA elements along with the demosaicing algorithm jointly determines the color rendition.

In some embodiments, the MIPI transceiver 2014 may be simplified as a MIPI receiver (MIPI RX) and the MIPI transceiver 2024 may be simplied as a MIPI transmitter (MIPI TX). MIPI is a data transmission standard that defines industry specifications for the design of mobile devices such as smartphones, tablets, laptops, and hybrid devices. MIPI interfaces play a strategic role in 5G mobile devices, connected cars, and Internet of Things (IOT) solutions.

In some embodiments, the primary image sensor 2012 may capture a first set of views of a scene using its objective lens 2010 and internal image sensor array 2013, and receive a second set of views of the same scene from the secondary image sensor (e.g., through the MIPI interfaces). The noise reduction circuit 2015 in the primary image sensor 2012 may then perform noise reduction based on the gathered views of the scene. This noise reduction circuit 2015 may be customized or optimized specifically for the model of the internal image sensor array 2013. For instance, with the knowledge that the internal image sensor array 2013 yields image noises in a specific band, the noise reduction circuit 2015 may be configured to perform noise reduction in that specific band but not others. This way, the noise reduction circuit 2015 may be simplified and consume less power.

In addition, the optional defective pixel correction circuit 2016 may correct defective pixels in the gathered views. Defect pixels are a common occurrence in digital camera sensors, either resulting from the manufacturing process or developing over time. Though low in quantity, they are very noticeable and can destroy the perceived quality of the images. For example, the optional defective pixel correction circuit 2016 may estimate the intensity value of the defective pixel by averaging neighboring information. For the confirmed defective pixels, interpolation may be performed to restore the image quality.

In some embodiments, the Bokeh effect processing circuit 2017 may be configured to compute a depth map based on the gathered views and render Bokeh effect based on the depth map. The different views captured by the internal image sensor array 2013 and received from the secondary image sensor 2022 inherently contain angle information. This angle information may later be used to construct the depth map, which may then be used for rendering the Bokeh effect.

For example, multi-view stereopsis algorithms may be executed to construct the depth map. The different angle views from the pixels covered by objective lens and the microlenses effectively form a stereo vision. The Bokeh effect processing circuit 2017 may compute plane-sweep volumes and optimize photometric consistency with error functions to measure similarities and disparities between pixel patches in the collection of views. Aside from photometric consistency, other 3D cues such as lighting, shadows, color, geometric structures, and semantic cues may also be considered to improve reconstruction accuracy. As another example, the depth map may be constructed using a deep convolutional neural network (ConvNet) designed to learn patch similarities and disparities for stereo matching.

The Bokeh effect processing circuit 2017 may then render the Bokeh effect to an output image based on the depth information in the depth map. The Bokeh effect may be rendered by blurring the background image. This step may be implemented using linear filtering, such as mean filtering. Gaussian filtering; or non-linear filtering, such as bilateral filtering, median filtering. In a particular case, the foreground target in the image is identified to select the focal plane, the blur radius of different regions in the image is then calculated according to the depth map and the focal plane, and finally a refocused image is generated based on the blur radius that meets the human aesthetic and Bokeh effect characteristics (e.g., the farther the objects are from the focal plane, the more blurred they are.).

Subsequently, the image processing circuit 2018 may be configured to perform additional image processing before sending the image with the Bokeh effect to the display 2019. These additional image processing may include image compressing, adding additional filtering effects, etc.

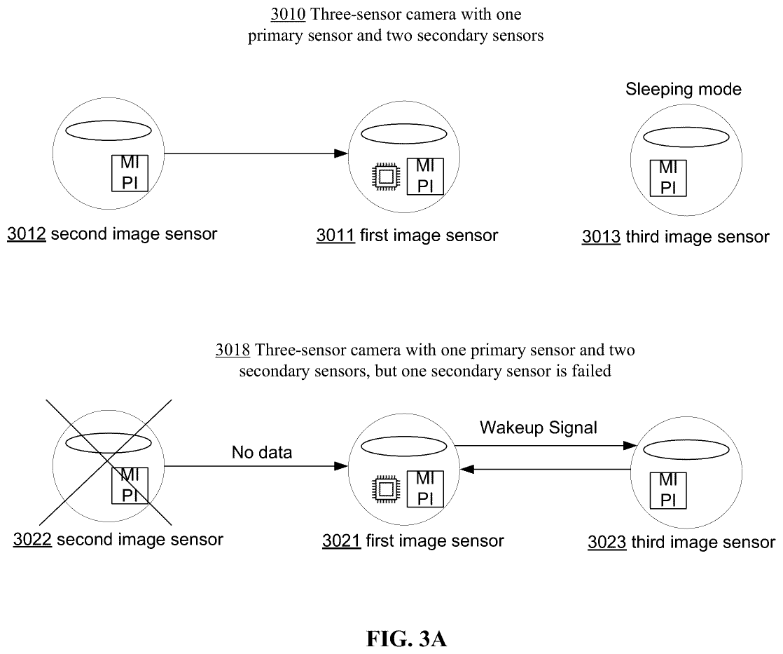

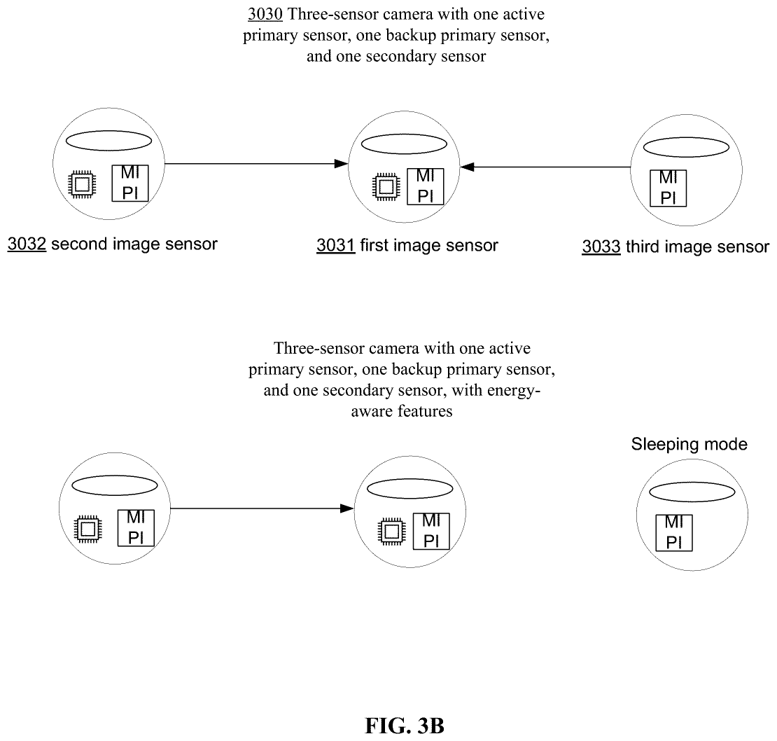

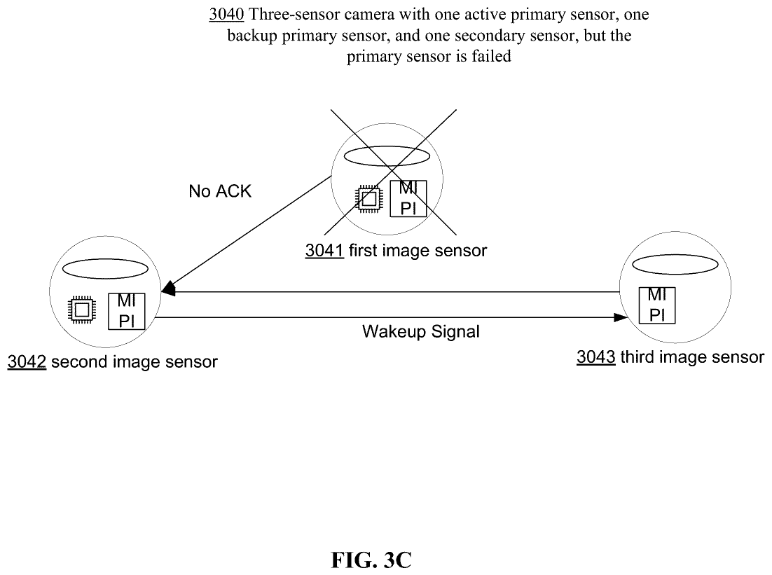

The two-sensor architecture illustrated in FIG. 2 shows the simplest configuration of edge camera. In some other embodiments, more than two sensors may be configured within the edge camera. FIGS. 3A-3C illustrates some example three-sensor edge cameras. The three-sensor edge cameras offer the advantage of stronger fault tolerance than the two-sensor edge camera. 2022.

FIG. 3A illustrates an exemplary three-sensor edge camera with hardware fault tolerance, according to some embodiments of this specification.

As shown in FIG. 3A, the three-sensor camera 3010 includes one primary image sensor (first image sensor 3011) and two secondary image sensors (second image sensor 3012 and third image sensor 3013). In some embodiments, all three sensors may be in active mode and capture three different views of a scene. The two secondary sensors may aggregate their captured views into the primary sensor, in which the primary sensor generates an image of the scene, compute the depth map based on the received views and the locally captured view, and then render Bokeh effect to the image based on the depth map.

In some embodiments, one secondary image sensor in the three-sensor camera 3010 may be configured to be in a power-saving mode (e.g., a sleeping mode) by default, and the other secondary image sensor and the primary sensor may be active to capture different views of a scene for Bokeh effect rendering purposes. For example, the first image sensor 3011 may include a lens, a local processor, and a MIPI interface, and both the second image sensor 3012 and the third image sensor 3013 include respective lenses and MIPI interfaces. The third image sensor 3013 may be in sleeping mode by default to reduce power consumption.

In a hardware failure scenario, the three-sensor camera 3018 may have a malfunction or defective secondary sensor. As an example, when the second image sensor 3022 fails, the third image sensor 3023 may be woke up and promoted to the active secondary sensor to work with the first image sensor. The failure detection and backup sensor activation may be implemented automatically. For instance, prior to the failure of the second image sensor 3022, the first image sensor 3021 always excepts an input data stream from the second image sensor 3022 once the first image sensor 3021 captures a view. When the data stream is not received from the second image sensor 3022 within a threshold time window, the first image sensor 3021 may determine the second image sensor 3022 is failed, and send a wakeup signal to the third image sensor 3023 to promote it to the active secondary sensor.

FIG. 3B illustrates another exemplary three-sensor edge camera, according to some embodiments of this specification. Different from the three-sensor edge cameras illustrated in FIG. 3A, the three-sensor edge camera 3030 in FIG. 3B includes one active primary sensor (first image sensor 3031), one pseudo secondary sensor (second image sensor 3032), and a secondary sensor (third image sensor 3033).

In some embodiments, the first image sensor 3031 may include a lens, a local processor, and a MIPI interface; the pseudo secondary sensor (second image sensor 3032) may also include a lens, a local processor, and a MIPI interface; while the third image sensor 3033 may include its lens and a MIPI interface. Even though the pseudo secondary sensor 3032 includes a processor, it keeps its processor in a power-saving mode and works as a secondary image sensor just capturing views and transmitting views to the primary sensor 3031. The third image sensor 3033 may be active to capture views of the scene from more angles, or kept in sleeping mode to conserve energy.

FIG. 3C illustrates another exemplary three-sensor edge camera with hardware fault tolerance, according to some embodiments of this specification. The three-sensor camera 3040 in FIG. 3C also includes one active primary sensor (first image sensor 3041), one pseudo secondary sensor (second image sensor 3042), and a secondary sensor (third image sensor 3043). The third image sensor 3043 may be configured in a sleeping mode by default to conserve energy.

When the active primary image sensor, i.e., the first image sensor 3041 fails or becomes defective, the pseudo secondary sensor (i.e., the second image sensor 3042) may promote itself as the active primary image sensor and wake up the third image sensor 3043 to be the secondary image sensor and work with the second image sensor 3042.

For example, prior to the failure of the first image sensor 3041, the second image sensor 3042 sends its captured views to the first image sensor 3041 for aggregation. The second image sensor 3042 expects to receive an acknowledgment signal from the first image sensor 3041 after sending its captured views. If the acknowledgment signal is not received within a threshold time window, the second image sensor 3042 may determine that the first image sensor is compromised, and triggers the subversion process. As another example, the first image sensor 3041 may detect its defective lens or pixels while processing the views it captured. If the number of defects is beyond a threshold, the first image sensor 3041 may demote itself and send a promotion signal to the second image sensor 3042 to be the new primary sensor. In this case, the second image sensor 3042 may activate its processor and wake up the third image sensor to continue the in-camera Bokeh effect rendering tasks.

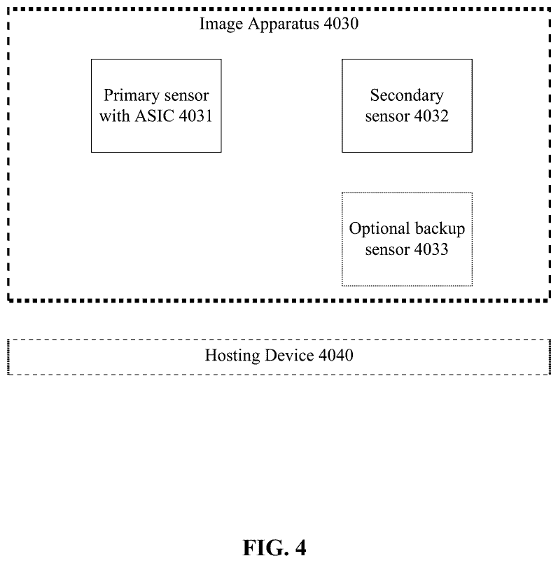

FIG. 4 is a schematic diagram of an example image apparatus 4030 for rendering the Bokeh effect, according to some embodiments of this specification. The image apparatus 4030 may refer to the edge camera FIG. 1-3C. The image apparatus 4030 may include a primary image sensor 4031 with a native processing circuit (e.g., ASIC) and a secondary image sensor 4032. In some embodiments, an optimal backup image sensor 4033 may be added to provide addition views for rendering Bokeh effect and/or fault tolerance. The image apparatus 4030 may be installed in a hosting device 4040, such as a smart phone, a tablet, a laptop, a monitor, an infotainment system in an autonomous vehicle, etc.

In some embodiments, the primary image sensor 4031 may include a first image sensor array, a first data transceiver, and a first processor, the secondary image sensor 4032 may include a second image sensor array and a second data transceiver. The primary image sensor 4031 may be configured to capture, using the first image sensor array, a first view of a scene. The secondary image sensor 4032 may be configured to capture, using the second image sensor array, a second view of the scene, and send, using the second data transceiver, the second view of the scene to the first sensor. The primary image sensor 4031 may be further configured to receive, using the first data transceiver, the second view of the scene, compute, using the first processor, a depth map of the scene based on the first view of the scene and the second view of the scene; and render, using the first processor, Bokeh effect to an image of the scene based on the depth map. The primary image sensor 4031 may then send, using the first data transceiver, the image of the scene with the rendered Bokeh effect to a display.

In some embodiments, the first data transceiver and the second data transceiver comprise mobile industry processor interfaces (MIPI).

In some embodiments, to compute the depth map of the scene, the primary image sensor 4031 is further configured to: determine a disparity between the first view and the second view of the scene; and generate depth information based on the disparity and position information of pixels that are captured in the first view and the second view of the scene.

In some embodiments, to render the Bokeh effect to an image of the scene, the primary image sensor 4031 is further configured to: generating the image of the scene based on the first view of the scene and the second view of the scene; determine a foreground and a background of the image of the scene based on the depth map; determine a depth of the background of the scene based on the depth map; and performing linear or non-linear filtering to blur the background of the image depending on a depth of the background.

In some embodiments, the optional backup image sensor 4033 may include a third image sensor array and a third data transceiver, and configured to capture, using the third image sensor array, a third view of the scene, and send, using the third data transceiver, the third view of the scene to the first sensor. Accordingly, the primary image sensor 4031 may be further configured to: receive, using the first data transceiver, the third view of the scene, and compute, using the first processor, the depth map of the scene based on the first view of the scene, the second view of the scene, and third view of the scene.

In some embodiments, the secondary image sensor 4032 further includes a second processor, and is further configured to: receive an instruction indicating a demotion of the first sensor and a promotion of the second sensor, receive, using the second data transceiver, the third view of the scene from the optimal backup image sensor 4033, compute, using the second processor, the depth map of the scene based on the second view of the scene and third view of the scene, and render, using the second processor, Bokeh effect to the image of the scene based on the depth map. In some embodiments, the instruction is received when a hardware failure is detected on the first sensor.

In some embodiments, the primary image sensor 4031 is configured to send an acknowledgement signal to the second sensor after receiving the second view of the scene, and when the acknowledgement signal is not received within a threshold time window, the second sensor is configured to: generate the instruction, and notify the optimal backup image sensor 4033 to redirect future data to the second sensor.

In some embodiments, the optional backup image sensor 4033 is configured to be in a power-saving mode by default.

In some embodiments, the secondary image sensor 4032 may receive an instruction indicating a demotion of the first sensor and a promotion of the second sensor, and send an enabling signal to the optimal backup image sensor 4033 to wake up from the power-saving mode. The optimal backup image sensor 4033, when wakes up from the power-saving mode, is configured to: capture, using the third image sensor array, a third view of the scene, and send, using the third data transceiver, the third view of the scene to the second sensor.

In some embodiments, the secondary image sensor 4032 may receive, using the second data transceiver, a third view of the scene from the optimal backup image sensor 4033, compute, using the second processor, the depth map of the scene based on the second view of the scene and third view of the scene, and render, using the second processor, Bokeh effect to an image of the scene based on the depth map.

In some embodiments, the native processing circuit in the primary image sensor 4031 may be an ASIC that is programmed according to at least a noise distribution of the first image sensor array.

Embodiments of this application provide apparatuses, systems, and corresponding methods for using multi-pixel micro lenses to capture different angle views using a single image sensor. The described methods can be performed by hardware implemented on an ASIC or an FPGA as a part of the image sensor. With the disclosed image sensor, an apparatus, for example, a smartphone, may use a single image senor (i.e., a single camera) to capture depth information and render pictures with depth perception. The apparatus may also use more than one image sensors each being implemented as disclosed in this application. This configuration takes the advantage of the microlens refraction to obtain stereo vision views, without using multiple cameras/image sensors.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuit.

When the functions disclosed herein are implemented in the form of software functional units and sold or used as independent products, they can be stored in a processor executable non-volatile computer-readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, where the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of example methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or sections of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C. B and C, or A, B, and C.” unless expressly indicated otherwise or indicated otherwise by context. Moreover, “and” is both joint and several, unless expressly indicated otherwise or indicated otherwise by context. Therefore, herein. “A and B” means “A and B, jointly or severally.” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might.” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. An image apparatus, comprising:
a first sensor comprising a first image sensor array, a first data transceiver, and a first processor;
a second sensor comprising a second image sensor array and a second data transceiver;
wherein:
the first sensor is configured to:
capture, using the first image sensor array, a first view of a scene;
the second sensor is configured to:
capture, using the second image sensor array, a second view of the scene, and
send, using the second data transceiver, the second view of the scene to the first sensor;
the first sensor is further configured to:
receive, using the first data transceiver, the second view of the scene,
compute, using the first processor, a depth map of the scene based on the first view of the scene and the second view of the scene; and
render, using the first processor, Bokeh effect to an image of the scene based on the depth map.

2. The image apparatus of claim 1, wherein the first sensor is further configured to send, using the first data transceiver, the image of the scene with the rendered Bokeh effect to a display.

3. The image apparatus of claim 1, wherein the first data transceiver and the second data transceiver comprise mobile industry processor interfaces (MIPI).

4. The image apparatus of claim 1, wherein to compute the depth map of the scene, the first sensor is further configured to:
determine a disparity between the first view and the second view of the scene; and
generate depth information based on the disparity and position information of pixels that are captured in the first view and the second view of the scene.

5. The image apparatus of claim 1, wherein to render the Bokeh effect to an image of the scene, the first sensor is further configured to:
generating the image of the scene based on the first view of the scene and the second view of the scene;
determine a foreground and a background of the image of the scene based on the depth map;
determine a depth of the background of the scene based on the depth map; and
performing linear or non-linear filtering to blur the background of the image depending on a depth of the background.

6. The image apparatus of claim 1, further comprising:
a third sensor comprising a third image sensor array and a third data transceiver,
wherein the third sensor is configured to:
capture, using the third image sensor array, a third view of the scene, and
send, using the third data transceiver, the third view of the scene to the first sensor;
the first sensor is further configured to:
receive, using the first data transceiver, the third view of the scene, and
compute, using the first processor, the depth map of the scene based on the first view of the scene, the second view of the scene, and third view of the scene.

7. The image apparatus of claim 6, wherein the second sensor further comprises a second processor, and is further configured to:
receive an instruction indicating a demotion of the first sensor and a promotion of the second sensor,
receive, using the second data transceiver, the third view of the scene from the third sensor,
compute, using the second processor, the depth map of the scene based on the second view of the scene and third view of the scene, and
render, using the second processor, Bokeh effect to the image of the scene based on the depth map.

8. The image apparatus of claim 7, wherein the instruction is received when a hardware failure is detected on the first sensor.

9. The image apparatus of claim 7, wherein:
the first sensor is configured to send an acknowledgement signal to the second sensor after receiving the second view of the scene, and
when the acknowledgement signal is not received within a threshold time window, the second sensor is configured to:
generate the instruction, and
notify the third sensor to redirect future data to the second sensor.

10. The image apparatus of claim 1, further comprising:
a third sensor comprising a third image sensor array and a third data transceiver,
wherein the third sensor is configured to be in a power-saving mode by default.

11. The image apparatus of claim 10, wherein the second sensor further comprises a second processor, and is further configured to:
receive an instruction indicating a demotion of the first sensor and a promotion of the second sensor, and
send an enabling signal to the third sensor to wake up from the power-saving mode.

12. The image apparatus of claim 11, wherein the third sensor, when wakes up from the power-saving mode, is configured to:
capture, using the third image sensor array, a third view of the scene, and
send, using the third data transceiver, the third view of the scene to the second sensor.

13. The image apparatus of claim 11, wherein the second sensor is further configured to:
receive, using the second data transceiver, a third view of the scene from the third sensor,
compute, using the second processor, the depth map of the scene based on the second view of the scene and third view of the scene, and
render, using the second processor, Bokeh effect to an image of the scene based on the depth map.

14. The image apparatus of claim 1, wherein the first processor comprises an application-specific integrated circuit (ASIC) designed for rendering Bokeh-effect.

15. The image apparatus of claim 14, wherein the ASIC is programmed according to at least a noise distribution of the first image sensor array.

16. The image apparatus of claim 1, wherein the first image sensor array and the second image sensor array are homogeneous sensors.

17. A hardware device, comprising:
a camera component and a display,
wherein the camera component comprises:
a first sensor comprising a first image sensor array, a first data transceiver, and a first processor;
a second sensor comprising a second image sensor array and a second data transceiver;
wherein:
the first sensor is configured to:
capture, using the first image sensor array, a first view of a scene;
the second sensor is configured to:
capture, using the second image sensor array, a second view of the scene, and
send, using the second data transceiver, the second view of the scene to the first sensor;
the first sensor is further configured to:
receive, using the first data transceiver, the second view of the scene,
compute, using the first processor, a depth map of the scene based on the first view of the scene and the second view of the scene;
render, using the first processor, Bokeh effect to an image of the scene based on the depth map; and
send the image of the scene with the rendered Bokeh effect to the display for displaying.

18. The hardware device of claim 17, wherein the hardware device is a smartphone or an autonomous vehicle.

19. The hardware device of claim 17, wherein the first data transceiver and the second data transceiver use mobile industry processor interfaces (MIPI).

20. The hardware device of claim 17, wherein to compute the depth map of the scene, the first sensor is further configured to:
determine a disparity between the first view and the second view of the scene; and
generate depth information based on the disparity and position information of pixels that are captured in the first view and the second view of the scene.
